(19) United States
(12) Patent Application Publication
(10) Pub. No.: US 2016/0249740 A1
(43) Pub. Date: Sep. 1, 2016

(54) Tandem Chair Unit

(71) Applicant: Ora Farmer, Davenport, IA (US)

(72) Inventor: Ora Farmer, Davenport, IA (US)

(21) Appl. No.: 14/974,347

(22) Filed: Dec. 18, 2015

Related U.S. Application Data
(60) Provisional application No. 62/121,621, filed on Feb. 27, 2015.

(51) Int. Cl. A47C 1/04; A61H 23/00; A47C 1/02; A61H 15/00; A47C 3/18; A47C 3/20

(52) U.S. Cl. CPC A47C 1/04; A47C 3/18; A47C 3/20; A47C 1/02; A61H 15/0078; A61H 23/004; A61H 2203/0431

(57) ABSTRACT

A tandem chair unit particularly useful for styling hair is provided. The tandem chair unit includes a front chair and a rear chair adjustably affixed to a base. The tandem chair unit includes a power seat assembly configured to allow each chair to be adjusted into various configurations. Each seat can be moved forward and backward, up and down, reclined forward and backward, and rotated clockwise and counterclockwise. In some embodiments, each chair unit may further include a massaging assembly and a heating assembly for providing comfort to the users seated therein.

### CROSS REFERENCE TO RELATED APPLICATION

This application claims the benefit of U.S. Provisional Application No. 62/121,621 filed on Feb., 27, 2015. The above identified patent application is herein incorporated by reference in its entirety to provide continuity of disclosure.

### FIELD OF THE INVENTION

The present invention relates to adjustable seating devices. Specifically, the present invention relates to a tandem chair unit having a front chair and a rear chair adjustably affixed to a base. The tandem chair unit includes a power seat assembly configured to actuate each chair in a variety of selectable directions. In some embodiments, each chair further includes a massaging assembly and a heating assembly.

### BACKGROUND OF THE INVENTION

Hairdressers, hair stylists, and other beauticians generally complain that the profession can be physically taxing. Typically, hair stylists complain that they suffer from back and leg problems, as well as hand and arm stress. Hair stylists usually stand throughout their work shift, which can put significant strain on their feet and back. Some hairstylists suffer from upper back pain, particularly their shoulder blades as the result of having to raise their hands in front of themselves to work on a client's hair.

Hairdressers can alleviate some of these pains by taking a few precautions. These include exercising, dieting, wearing proper footwear, and receiving massage therapy. One of the most helpful precautions is to purchase a side chair on which the stylist can sit while styling a client's hair. Some types of side chairs can be raised or lowered as desired by the stylist. In this way, a user can potentially alleviate their pain in their upper back. However, these chairs often are limited in movement and prevent the hairdresser from doing his or her best work. Therefore, there exists a need for a tandem chair unit that is actuated into a variety of configurations, which can allow a user to work on hair while sitting. This is particularly beneficial for those that are braiding another person's hair.

Devices have been disclosed in the prior art that relate to chairs for barbers and hair stylists. Other devices generally relate to tandem chair assemblies having a frame, a plurality of seating units, and an optional integral table. These include devices that have been patented and published in patent application publications. These prior art devices, however, fail to provide a pair of adjustable chairs disposed on a base, wherein the chairs are oriented in the same direction.

The present invention provides a tandem chair unit having a front chair and a rear chair, wherein the rear chair is directly behind the front chair such that both chairs are facing the same direction. Each chair is adjustably affixed to a base. The tandem chair unit further includes a power seat assembly configured to actuate each chair in a variety of configurations. The chairs can be arranged in various configurations by moving each chair forward and backward or up and down. Further, each chair can be reclined forward and backward and can rotate clockwise and counterclockwise. Each chair further includes a heating assembly and a massaging assembly. The tandem chair unit is particularly beneficial as it allows a person sitting in the rear chair to style the hair of the person sitting in the front chair without having to stand.

It is therefore submitted that the present invention is substantially divergent in design elements from the prior art, and consequently it is clear that there is a need in the art for an improvement to tandem chair units. In this regard, the instant invention substantially fulfills these needs.

### SUMMARY OF THE INVENTION

In view of the foregoing disadvantages inherent in the known types of tandem chair units now present in the prior art, the present invention provides a new and improved tandem chair unit, wherein the same can be utilized for facilitating the styling of hair for a person sitting in the front chair by the person sitting in the rear chair.

It is therefore an object of the invention to provide a new and improved tandem chair unit that has all of the advantages of the prior art and none of the disadvantages.

Another object of the present invention is to provide a new and improved tandem chair unit having a base, wherein a pair of chairs are adjustably affixed thereon.

Yet another object of the present invention is to provide a new and improved tandem chair unit, wherein the pair of chairs includes a power seat assembly configured to move each chair in a variety of selectable directions including forward and backward, up and down, recline forward and backward, and rotate clockwise and counterclockwise.

Still yet another object of the present invention is to provide a new and improved tandem chair unit, wherein each chair includes a heating assembly configured to generate heat by having an electric current pass through a thermoelectric resistance wire.

A further object of the present invention is to provide a new and improved tandem chair unit, wherein each chair includes a massaging assembly configured to create vibrations or provide a massage.

Still yet another object of the present invention is to provide a new and improved chair tandem unit, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the tandem chair unit.

FIG. 2 shows a schematic diagram of the power seat assembly of the tandem chair unit.

FIG. 3 shows a schematic diagram of the heating assembly of the tandem chair unit.

FIG. 4 shows a schematic diagram of the massaging assembly of the tandem chair unit.

### DETAILED DESCRIPTION OF THE INVENTION

Reference is made herein to the attached drawings. Like reference numerals are used throughout the drawings to depict like or similar elements of the tandem chair unit of the present invention. For the purposes of presenting a brief and clear description of the present invention, the preferred embodiment will be discussed as used for allowing a person sitting in the rear chair to style to the hair of the person sitting in the front chair. The figures are intended for representative purposes only and should not be considered to be limiting in any respect.

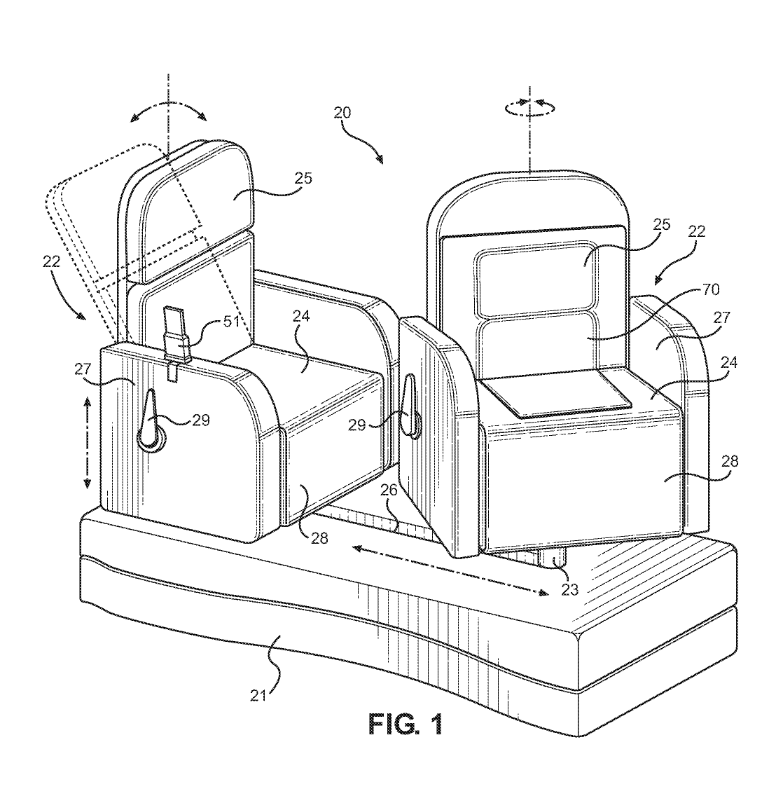

Referring now to FIG. 1, there is shown a perspective view of the tandem chair unit. The tandem chair unit 20 includes a base 21 having a pair of chairs 22 adjustably positioned thereon. The chairs 22 are positioned such that a front chair is positioned directly in front of a rear chair, so that the chairs 22 are facing the same direction. The chairs 22 are adapted to be adjusted into various configurations so that a user sitting in the rear chair can comfortably style the hair of the person sitting in the front chair. Each chair 22 includes a seat 24 and a backrest 25. The backrest 25 is pivotally connected to the seat 24 so that the angle or incline of the backrest 25 can be adjusted as desired by the user. The chairs 22 may further include a pair of armrests 27 depending upon the embodiment. In some embodiments, each seat 24 is pivotally attached to a footrest 28 that is operably connected to a spring-biased lever 29. The lever 29 is preferably disposed on a side of each seat 24 and allows the user to extend the footrest 28 outwardly for the user to rest his or her feet thereon. Preferably, the exterior of chair 22 is composed from a leather or polyester material, however, those or ordinary skill in the art will readily envision a variety of other materials for constructing the chairs 22.

The tandem chair unit 20 includes a power seat assembly that allows for each chair 22 to be adjusted into various configurations. Each chair 22 is positioned on a shaft 23 that is arranged vertically and is connected to the underside of the chair 22. The shaft 23 is preferably telescopic so that the length of the shaft 23 can be selectively increased or decreased. In this way, the height of each chair can be adjusted by adjusting the length of the shaft 23. For example, it may be desirable to increase the height of the rear chair and decrease the height of the front chair so that the stylist has greater access to the hair of the person seated in the front chair. The length of the shaft 23 can be increased or decreased by means of an electric motor, pneumatic actuator, or hydraulic actuator, among other similar devices.

The shaft 23 further allows for the chairs to be rotated. Preferably, the chairs 22 can be rotated in 360 degrees. The chairs 22 are adapted to rotate about the shaft 23. The shaft 23 itself may rotate or the chair 22 may be rotatably connected to the shaft 23 to allow for rotation thereof. In this way, the stylist seated in the rear chair can easily move the user seated in the front chair into various positions to give the stylist greater access to the sides or front of the user's head. This prevents the stylist from having to walk around the user in order to access different portions of the user's hair.

The chairs 22 can also be moved in forward and backward directions so as to adjust the spacing between the chairs 22. The base 21 comprises a channel or track 26 in which the shafts 23 of each chair are positioned. The shafts 23 can be moved within the track 26 in order to move the chairs 22 towards or away from one another. It may be desirable for the stylist to move the chairs 22 closer together so that the stylist is positioned closely to the person's hair so that the stylist can more easily reach the person's hair. The position of the chairs 22 can be adjusted by means of an electric motor, pneumatic actuator, or hydraulic actuator, among other similar devices.

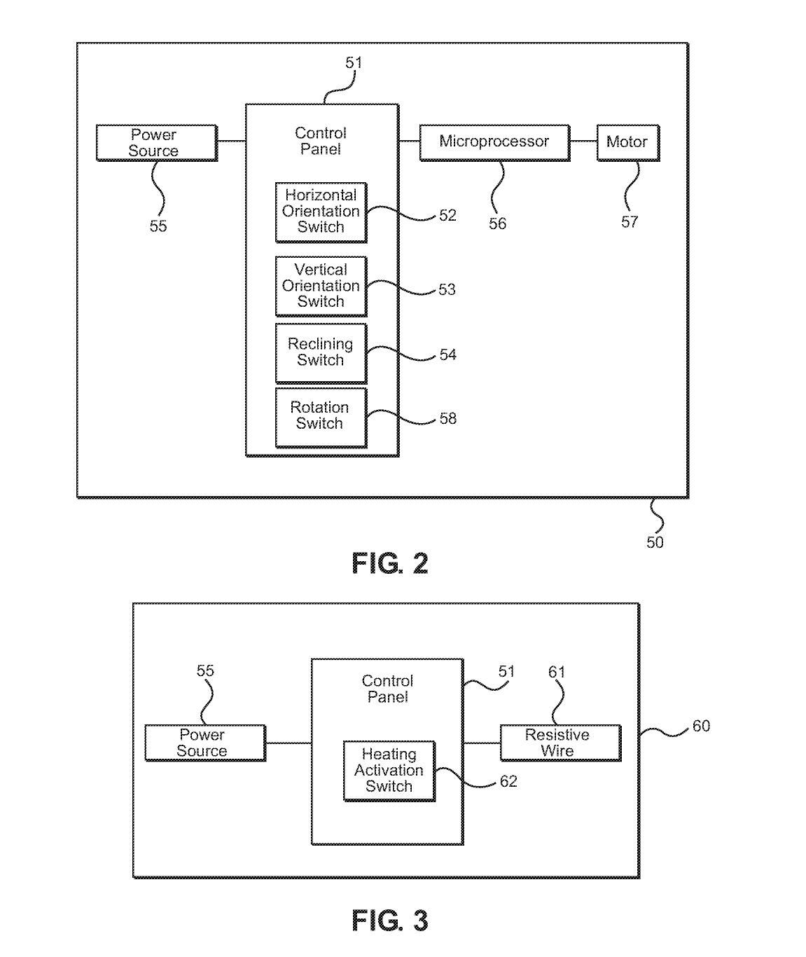

Referring now to FIG. 2, there is shown a schematic diagram of the power seat assembly. The power seat assembly 50 is configured to allow a user to actuate each chair in a variety of selectable directions. In this way, the user sitting in the rear chair can adjust the front chair or the rear chair. The power seat assembly 50 includes a power source 55 electrically connected to a control panel 51 having at least one control thereon. Preferably, multiple controls are provided for each chair 22 such as a horizontal orientation control 52, a vertical orientation control 53, a reclining control 54, and a rotation control 58. The control panel 51 is preferably positioned on the rear chair where the stylist is seated so that the stylist has control of the positioning of each chair.

In some embodiments, the power seat assembly 50 further includes a microprocessor 56 that is in electric communication with the controls 52, 53, 54, 58. The microprocessor 56 is configured to compare the actual position of the chair with the position requested by the user, and adjust the chair accordingly via a motor 57 until the actual position matches the requested position. It is understood that various types of motors or actuators may be used in order to change the position of the chairs, such as an electric motor, a pneumatic actuator, or a hydraulic actuator, among others.

Referring now to FIG. 3, there is shown a schematic diagram of the heating assembly. In some embodiments, the tandem chair unit further comprises a heating assembly integrated into one or both of the chairs in order to provide additional comfort to the user seated therein. The heating assembly 60 is configured to warm the chair if the user so desires. Preferably, the heating assembly 60 is embedded within the seat and backrest of each chair. The heating assembly 60 includes a thermoelectric elongated resistive wire 61 that generates heat by having an electric current pass therethrough. Preferably, the elongated resistive wire 61 is affixed in a substantially serpentine pattern through the chair, however, it is anticipated that those of ordinary skill in the art will readily envision other shapes and patterns for affixing the resistive wire 61 to allow for efficient heating. These alterations and modifications are deemed to be within the spirit and scope of the inventive embodiments described herein.

Preferably, the resistive wire 61 includes an electric conductor encased in an insulated jacket preferably made from a proprietary blend of plastic. Some exemplary electric conductors include copper, aluminum, silver and any other suitable equivalents. As it will be readily apparent to those skilled in the art, any suitable material may achieve the above stated objects of the heating assembly 60. Those of ordinary skill in the art will readily envision other sizes, shapes, and material used for various components of the heating assembly 60. These variations, alterations, and modifications may be varied without departing from the inventive embodiments described herein.

The heating assembly 60 is electrically connected to the power source 55 via a heating activation switch 62, which is configured to provide electrical communication to the heating assembly 60 in order to generate heat through the resistive wire 26. The heating activation switch 62 is disposed on the control panel 51 that is designed to activate and deactivate electrical communication between the heating assembly 60 and power source 55. Preferably, the heating activation switch 62 is a depressible button, however, other suitable switches are likewise contemplated.

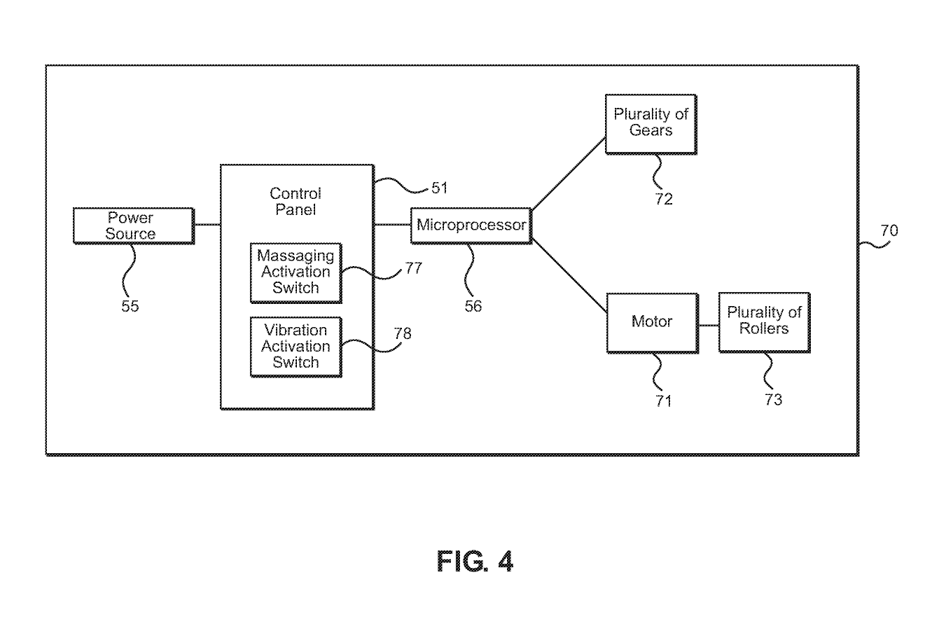

Referring now to FIG. 4, there is shown a schematic diagram of the massaging assembly. The massaging assembly 70 includes a massaging activation switch 77 and a vibrating activation switch 78 disposed on the control panel 51. The activation switch 77, 78 are in electric communication with the power source 55 and the microprocessor 56 in order to drive the massaging assembly 70. The microprocessor 56 is configured to transmit an electrical signal to a motor 71, a plurality of gears 72, and a plurality of rollers 73 in order to create vibrations or provide a massage.

The plurality of gears 72 are each configured to create vibrations along each chair to provide a massage for a user. Each gear 72 includes a weighted wheel, wherein the weight of each weighted wheel is not centered therein, which makes the wheel unbalanced. Each gear 72 further includes a motor therein configured to cause the weighted wheel to rotate, which causes a vibration. The plurality of rollers 73 are configured to move along a track embedded within each chair. The track is preferably linear in shape, however, those of ordinary skill in the art will readily envision a variety of other patterns and shape for the track 77. The plurality of rollers 73 are driven along the track by the motor 71 to provide a massage to the user.

As it will be readily apparent to those skilled in the art, any suitable material may achieve the above stated objects of the massaging assembly 70. Those of ordinary skill in the art will readily envision other sizes, shapes, and material used for various components of the massaging assembly 70. These variations, alterations, and modifications may be varied without departing from the inventive embodiments described herein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tandem chair unit, comprising:
a base having a pair of chairs adjustably affixed thereon;
a power seat assembly operably connected to said pair of chairs for adjusting the positioning of each of said pair of chairs, wherein said power seat assembly allows aid chairs to be rotated, moved laterally, moved vertically, and reclined.

2) The tandem chair unit of claim 1, wherein said power seat assembly comprises a control panel adapted to allow a user to select the configuration of each of said pair of chairs.

3) The tandem chair unit of claim 2, wherein:
said control panel includes a horizontal orientation switch, a vertical orientation switch, a reclining switch, and a rotation switch;
wherein said horizontal orientation switch is configured to adjust each of said pair of chairs forward and backward;
wherein said vertical orientation switch is configured to adjust each of said pair of chairs up and down;
wherein said reclining switch is configured to recline each of said pair of chairs forward and backward;
wherein said rotation switch is configured to rotate each of said pair of chairs clockwise and counterclockwise.

4) The tandem chair unit of claim 1, wherein:
said power seat assembly further comprises a motor adapted to adjust the position of said pair of chairs.

5) The tandem chair unit of claim 1, further comprising a heating assembly integrated into each of said pair of chairs.

6) The tandem chair of claim 5, wherein said heating assembly comprises a heating activation switch and a thermoelectric elongated resistive wire, wherein said thermoelectric elongated resistive wire is configured to generate heat by having an electric current pass therethrough.

7) The tandem chair unit of claim 1, further comprising a massaging assembly integrated into said pair of chairs.

8) The tandem chair unit of claim 7, wherein said massaging assembly comprises a motor, a plurality of gears, and a plurality of rollers.

9) The tandem chair unit of claim 7, wherein each of said plurality of gears is configured to create vibrations along each of said pair of chairs.

10) The tandem chair unit of claim 7, wherein each of said plurality of rollers is configured to move along each of said pair of chairs via said motor to provide a massage to said user.
